(19) United States
(12) Patent Application Publication
(10) Pub. No.: US 2026/0141613 A1
(43) Pub. Date: May 21, 2026

(54) LAYERED ACCESSORY ADJUSTMENT FOR 3D ASSETS

(71) Applicant: Roblox Corporation, San Mateo, CA (US)

(72) Inventor: Alexander EHRATH, San Mateo, CA (US)

(73) Assignee: Roblox Corporation, San Mateo, CA (US)

(21) Appl. No.: 18/955,242

(22) Filed: Nov. 21, 2024

(51) Int. Cl. G06T 15/04; G06T 13/40; G06T 15/06

(52) U.S. Cl. CPC G06T 15/04; G06T 13/40; G06T 15/06

(57) ABSTRACT

According to one aspect of the present disclosure, computer-implemented method is provided. The method includes transforming, by a processor, an inner geometry of an avatar head to a spherical inner geometry. The method includes mapping, by the processor, an outer geometry of an accessory for the avatar head to the spherical inner geometry of the avatar head. The method includes, after mapping the outer geometry of the accessory, rotating, by the processor, the outer geometry of the accessory with respect to the spherical inner geometry of the avatar head. The method includes, after the rotating, remapping, by the processor, the outer geometry of the accessory to the inner geometry of the avatar head. The method includes, based on the remapping, rendering, by the processor, the accessory coupled to the avatar head.

### TECHNICAL FIELD

Embodiments relate generally to online virtual experience platforms, and more particularly, to methods, systems, and computer readable media for adjusting a position of a layered accessory on an avatar head.

### BACKGROUND

Online platforms, such as virtual experience platforms and online gaming platforms, can include rendering an avatar head with a layered accessory (e.g., beanie, baseball cap, top hat, etc.) positioned thereon.

Head accessories, such as beanies, can be equipped on avatars to fit tightly against the head. These accessories fit so tightly on the avatar head that changing their orientation introduces clipping unless the vertices are re-computed based on the new orientation relative to the underlying head. However, the re-computation is costly to perform in real time on mid-tier or high-end phones.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to one aspect of the present disclosure, computer-implemented method is provided. The method includes transforming, by a processor, an inner geometry of an avatar head to a spherical inner geometry. The method includes mapping, by the processor, an outer geometry of an accessory for the avatar head to the spherical inner geometry of the avatar head. The method includes, after mapping the outer geometry of the accessory, rotating, by the processor, the outer geometry of the accessory with respect to the spherical inner geometry of the avatar head. The method includes, after the rotating, remapping, by the processor, the outer geometry of the accessory to the inner geometry of the avatar head. The method includes, based on the remapping, rendering, by the processor, the accessory coupled to the avatar head.

In some implementations, transforming the inner geometry of the avatar head to the spherical inner geometry includes calculating a center point of the inner geometry of the avatar head. In some implementations, transforming the inner geometry of the avatar head to the spherical inner geometry includes adjusting vertices of the inner geometry to be a same distance from the center point to transform the inner geometry to the spherical inner geometry.

In some implementations, mapping the outer geometry of an accessory for the avatar head to the spherical inner geometry of the avatar head includes calculating a first set of barycentric coordinates that correspond to intersection points on an outer surface of the inner geometry for rays that extend from the center point of the inner geometry to the vertices of the outer geometry. In some implementations, mapping the outer geometry of an accessory for the avatar head to the spherical inner geometry of the avatar head includes calculating a delta for each vertex in the spherical inner geometry. In some implementations, the delta is a difference in an original position of the vertex in the inner geometry and a new position of the vertex in the spherical inner geometry. In some implementations, mapping the outer geometry of an accessory for the avatar head to the spherical inner geometry of the avatar head includes transforming the outer geometry of the accessory to a spherical outer geometry. In some implementations, mapping the outer geometry of an accessory for the avatar head to the spherical inner geometry of the avatar head includes mapping vertices of the spherical outer geometry of the accessory to vertices of the spherical inner geometry of the avatar head based on the first set of barycentric coordinates.

In some implementations, rotating the outer geometry of the accessory with respect to the spherical inner geometry of the avatar head includes rotating the vertices of the spherical outer geometry of the accessory and the rays that extend from the center point of the spherical inner geometry of the avatar head to the vertices of the spherical outer geometry.

In some implementations, remapping the outer geometry of the accessory to the inner geometry of the avatar head includes calculating a second set of barycentric coordinates that correspond to new intersection points on an outer surface of the spherical inner geometry for the rays that extend from a center point of the spherical inner geometry to the vertices of the spherical outer geometry. In some implementations, remapping the outer geometry of the accessory to the inner geometry of the avatar head includes mapping the vertices of the spherical outer geometry to the vertices of the spherical inner geometry based on the second set of barycentric coordinates. In some implementations, remapping the outer geometry of the accessory to the inner geometry of the avatar head includes transforming the spherical outer geometry back to the outer geometry based on the second set of barycentric coordinates.

In some implementations, rendering the accessory in a rotated position resting on the avatar head includes rendering the accessory coupled to the avatar head after the spherical outer geometry is transformed back to the outer geometry.

In some implementations, the mapping the outer geometry of the accessory for the avatar head to the spherical inner geometry of the avatar head is performed using a linear deformer. In some implementations, the remapping the outer geometry of the accessory to the inner geometry of the avatar head is performed using an inverse-linear deformer.

According to another aspect of the present disclosure, a non-transitory computer-readable medium with instructions stored thereon that, when executed by one or more hardware processors, cause the one or more hardware processors to perform operations is provided. The operations include transforming an inner geometry of an avatar head to a spherical inner geometry. The operations include mapping an outer geometry of an accessory for the avatar head to the spherical inner geometry of the avatar head. The operations include, after mapping the outer geometry of the accessory, rotating the outer geometry of the accessory with respect to the spherical inner geometry of the avatar head. The operations include, after the rotating, remapping the outer geometry of the accessory to the inner geometry of the avatar head. The operations include, based on the remapping, rendering the accessory coupled to the avatar head.

In some implementations, transforming the inner geometry of the avatar head to the spherical inner geometry includes calculating a center point of the inner geometry of the avatar head. In some implementations, transforming the inner geometry of the avatar head to the spherical inner geometry includes adjusting vertices of the inner geometry to be a same distance from the center point to transform the inner geometry to the spherical inner geometry.

In some implementations, mapping the outer geometry of an accessory for the avatar head to the spherical inner geometry of the avatar head includes calculating a first set of barycentric coordinates that correspond to intersection points on an outer surface of the inner geometry for rays that extend from the center point of the inner geometry to the vertices of the outer geometry. In some implementations, mapping the outer geometry of an accessory for the avatar head to the spherical inner geometry of the avatar head includes calculating a delta for each vertex in the spherical inner geometry. In some implementations, the delta is a difference in an original position of the vertex in the inner geometry and a new position of the vertex in the spherical inner geometry. In some implementations, mapping the outer geometry of an accessory for the avatar head to the spherical inner geometry of the avatar head includes transforming the outer geometry of the accessory to a spherical outer geometry. In some implementations, mapping the outer geometry of an accessory for the avatar head to the spherical inner geometry of the avatar head includes mapping vertices of the spherical outer geometry of the accessory to vertices of the spherical inner geometry of the avatar head based on the first set of barycentric coordinates.

In some implementations, rotating the outer geometry of the accessory with respect to the spherical inner geometry of the avatar head includes rotating the vertices of the spherical outer geometry of the accessory and the rays that extend from the center point of the spherical inner geometry of the avatar head to the vertices of the spherical outer geometry.

In some implementations, remapping the outer geometry of the accessory to the inner geometry of the avatar head includes calculating a second set of barycentric coordinates that correspond to new intersection points on an outer surface of the spherical inner geometry for the rays that extend from a center point of the spherical inner geometry to the vertices of the spherical outer geometry. In some implementations, remapping the outer geometry of the accessory to the inner geometry of the avatar head includes mapping the vertices of the spherical outer geometry to the vertices of the spherical inner geometry based on the second set of barycentric coordinates. In some implementations, remapping the outer geometry of the accessory to the inner geometry of the avatar head includes transforming the spherical outer geometry back to the outer geometry based on the second set of barycentric coordinates.

In some implementations, rendering the accessory in a rotated position resting on the avatar head includes rendering the accessory coupled to the avatar head after the spherical outer geometry is transformed back to the outer geometry.

In some implementations, the mapping the outer geometry of the accessory for the avatar head to the spherical inner geometry of the avatar head is performed using a linear deformer. In some implementations, the remapping the outer geometry of the accessory to the inner geometry of the avatar head is performed using an inverse-linear deformer.

According to a further aspect of the present disclosure, a computing device is provided. The computing device includes one or more hardware processors. The computing device includes a non-transitory computer readable medium coupled to the one or more hardware processors, with instructions stored thereon, that when executed by the one or more hardware processors to perform operations. The operations include transforming an inner geometry of an avatar head to a spherical inner geometry. The operations include mapping an outer geometry of an accessory for the avatar head to the spherical inner geometry of the avatar head. The operations include, after mapping the outer geometry of the accessory, rotating the outer geometry of the accessory with respect to the spherical inner geometry of the avatar head. The operations include, after the rotating, remapping the outer geometry of the accessory to the inner geometry of the avatar head. The operations include, based on the remapping, rendering the accessory coupled to the avatar head.

In some implementations, transforming the inner geometry of the avatar head to the spherical inner geometry includes calculating a center point of the inner geometry of the avatar head. In some implementations, transforming the inner geometry of the avatar head to the spherical inner geometry includes adjusting vertices of the inner geometry to be a same distance from the center point to transform the inner geometry to the spherical inner geometry.

In some implementations, mapping the outer geometry of an accessory for the avatar head to the spherical inner geometry of the avatar head includes calculating a first set of barycentric coordinates that correspond to intersection points on an outer surface of the inner geometry for rays that extend from the center point of the inner geometry to the vertices of the outer geometry. In some implementations, mapping the outer geometry of an accessory for the avatar head to the spherical inner geometry of the avatar head includes calculating a delta for each vertex in the spherical inner geometry. In some implementations, the delta is a difference in an original position of the vertex in the inner geometry and a new position of the vertex in the spherical inner geometry. In some implementations, mapping the outer geometry of an accessory for the avatar head to the spherical inner geometry of the avatar head includes transforming the outer geometry of the accessory to a spherical outer geometry. In some implementations, mapping the outer geometry of an accessory for the avatar head to the spherical inner geometry of the avatar head includes mapping vertices of the spherical outer geometry of the accessory to vertices of the spherical inner geometry of the avatar head based on the first set of barycentric coordinates.

In some implementations, rotating the outer geometry of the accessory with respect to the spherical inner geometry of the avatar head includes rotating the vertices of the spherical outer geometry of the accessory and the rays that extend from the center point of the spherical inner geometry of the avatar head to the vertices of the spherical outer geometry.

In some implementations, remapping the outer geometry of the accessory to the inner geometry of the avatar head includes calculating a second set of barycentric coordinates that correspond to new intersection points on an outer surface of the spherical inner geometry for the rays that extend from a center point of the spherical inner geometry to the vertices of the spherical outer geometry. In some implementations, remapping the outer geometry of the accessory to the inner geometry of the avatar head includes mapping the vertices of the spherical outer geometry to the vertices of the spherical inner geometry based on the second set of barycentric coordinates. In some implementations, remapping the outer geometry of the accessory to the inner geometry of the avatar head includes transforming the spherical outer geometry back to the outer geometry based on the second set of barycentric coordinates.

In some implementations, rendering the accessory in a rotated position resting on the avatar head includes rendering the accessory coupled to the avatar head after the spherical outer geometry is transformed back to the outer geometry.

In some implementations, the mapping the outer geometry of the accessory for the avatar head to the spherical inner geometry of the avatar head is performed using a linear deformer. In some implementations, the remapping the outer geometry of the accessory to the inner geometry of the avatar head is performed using an inverse-linear deformer.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications; and all such modifications are within the scope of this disclosure.

### BRIEF DESCRIPTION OF DRAWINGS

FIG. 1 is a diagram of an example network environment, in accordance with some implementations.

FIG. 2A illustrates an accessory in a neutral position on an avatar head, in accordance with some implementations.

FIG. 2B illustrates an accessory in a rotated position on an avatar head, in accordance with some implementations.

FIG. 3A is a diagram illustrating a first set of operations for rotating an accessory, in accordance with some implementations.

FIG. 3B illustrates an inner geometry of an avatar head cage and an outer geometry of an accessory in a neutral position, in accordance with some implementations.

FIG. 3C is a diagram illustrating a second set of operations for rotating an accessory, in accordance with some implementations.

FIG. 3D illustrates a spherical inner geometry of an avatar head cage and a spherical outer geometry of an accessory in a neutral position, in accordance with some implementations.

FIG. 3E is a diagram illustrating a third set of operations for rotating an accessory, in accordance with some implementations.

FIG. 3F illustrates a spherical inner geometry of an avatar head cage and a spherical outer geometry of an accessory in a rotated position, in accordance with some implementations.

FIG. 3G is a diagram illustrating a fourth set of operations for rotating an accessory, in accordance with some implementations.

FIG. 3H illustrates an inner geometry of an avatar head cage and an outer geometry of an accessory in a rotated position, in accordance with some implementations.

FIG. 4 illustrates a flowchart of an example method for rotating an accessory, in accordance with some implementations.

FIG. 5 is a block diagram illustrating an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations”, “an implementation”, “an example implementation”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

Various embodiments are described herein in the context of three-dimensional (3D) avatars that are used in a 3D virtual experience or environment. Some implementations of the techniques described herein may be applied to various types of 3D environments, such as a virtual reality (VR) conference, a 3D session (e.g., an online lecture or other type of presentation involving 3D avatars), a virtual concert, an augmented reality (AR) session, or in other types of 3D environments that may include one or more users that are represented in the 3D environment by one or more 3D avatars.

As used herein, the term “accessory” may refer to any type of virtual object that can be positioned on and conform to the shape of an avatar head. Non-limiting examples of an accessory include, e.g., a baseball cap, a top hat, a turban, a wrapped scarf, a fedora, a sunhat, a visor, headphones, a snake, etc.

Some 3D avatars may be rendered with a layered accessory placed on its head. The avatar head is rendered based on an inner geometry (e.g., a head cage) made up of a plurality of polygons, and the accessory is rendered based on an outer geometry, which is also made up of a plurality of polygons. Typically, the shape the outer geometry of the accessory relative to the inner geometry of the avatar head cage is “baked” into the data. For instance, to bind the accessory to the avatar head, some techniques take each of the outer geometry vertices and find the closest point to the closest corresponding polygon (e.g., triangle) of the inner geometry. Then, the polygon, barycentric coordinate, and vector from this point to the outer geometry vertex is recorded. Using this technique, the accessory is bound to the avatar head such that the orientation of the accessory cannot be changed without introducing clipping. This is unless the vertices of the outer geometry are re-computed with the new orientation relative to the head underneath as an input. This real-time operation is computationally prohibitive on most user devices.

To overcome these and other challenges, the present disclosure uses the existing accessory vertex data with respect to the avatar head as a source of truth to then compute a rotated accessory that still conforms to the shape of the avatar head. This is accomplished by transforming the avatar head vertices from the geometric center out into a sphere. Then, the original accessory vertices are linearly mapped and transformed to this new spherical head shape. Next, the accessory vertices are rotated about the center point of the avatar head to the new desired rotation. Finally, the new vertices are inverse transformed from the spherical space back to the original space.

Using the present techniques, an accessory in a rotated position that conforms to the avatar head shape may be computed with reduced computational complexity and increased speed, as compared with other examples. The techniques set forth herein are not limited to the avatar head and may extended to other body parts, e.g., cylinders around arms and legs.

### System Architecture

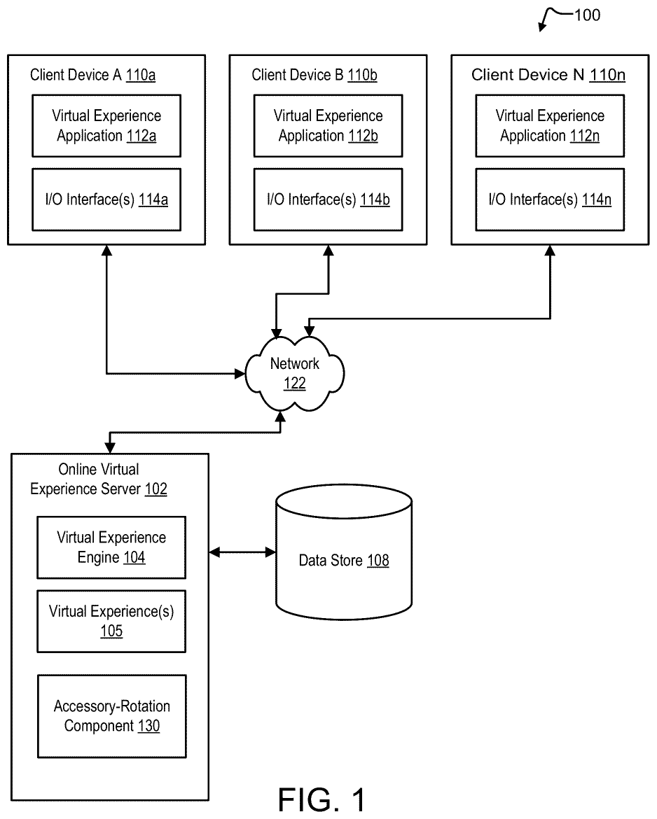

FIG. 1 illustrates an example network environment 100, in accordance with some implementations of the disclosure. FIG. 1 and the other figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The network environment 100 (also referred to as a “platform” herein) includes an online virtual experience server 102, a data store 108, a client device 110 (or multiple client devices), and a third-party server 118, all connected via a network 122.

The online virtual experience server 102 can include, among other things, a virtual experience engine 104, one or more virtual experiences 105, and an accessory-rotation component 130. The online virtual experience server 102 may be configured to provide virtual experiences 105 to one or more client devices 110, and to render a layered accessory in a rotated position on an avatar head such that it still conforms to the shape of the avatar head via the accessory-rotation component 130, in some implementations.

Data store 108 is shown coupled to online virtual experience server 102 but in some implementations, can also be provided as part of the online virtual experience server 102. The data store may, in some implementations, be configured to store corresponding outer geometries for different types of accessories (e.g., beanie, baseball cap, top hat, etc.) in association with the accessory-rotation component 130.

The client devices 110 (e.g., 110a, 110b, 110n) can include a virtual experience application 112 (e.g., 112a, 112b, 112n) and an I/O interface 114 (e.g., 114a, 114b, 114n), to interact with the online virtual experience server 102, and to view, for example, graphical user interfaces (GUI) through a computer monitor or display (not illustrated). In some implementations, the client devices 110 may be configured to execute and display virtual experiences.

Network environment 100 is provided for illustration. In some implementations, the network environment 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In some implementations, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, virtual server, etc.). In some implementations, a server may be included in the online virtual experience server 102, be an independent system, or be part of another system or platform. In some implementations, the online virtual experience server 102 may be a single server, or any combination a plurality of servers, load balancers, network devices, and other components. The online virtual experience server 102 may also be implemented on physical servers, but may utilize virtualization technology, in some implementations. Other variations of the online virtual experience server 102 are also applicable.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user (e.g., via client device 110) with access to online virtual experience server 102.

The online virtual experience server 102 may also include a website (e.g., one or more web pages) or application back-end software that may be used to provide a user with access to content provided by online virtual experience server 102. For example, users (or developers) may access online virtual experience server 102 using the virtual experience application 112 on client device 110, respectively.

In some implementations, online virtual experience server 102 may include digital asset and digital virtual experience generation provisions. For example, the platform may provide administrator interfaces allowing the design, modification, unique tailoring for individuals, and other modification functions. In some implementations, virtual experiences may include two-dimensional (2D) games, three-dimensional (3D) games, virtual reality (VR) games, or augmented reality (AR) games, for example. In some implementations, virtual experience creators and/or developers may search for virtual experiences, combine portions of virtual experiences, tailor virtual experiences for particular activities (e.g., group virtual experiences), and other features provided through the online virtual experience server 102.

In some implementations, online virtual experience server 102 or client device 110 may include the virtual experience engine 104 or virtual experience application 112. In some implementations, virtual experience engine 104 may be used for the development or execution of virtual experiences 105. For example, virtual experience engine 104 may include a rendering engine (“renderer”) for 2D, 3D, VR, or AR graphics, a physics engine, a collision detection engine (and collision response), sound engine, scripting functionality, haptics engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.).

The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110 (not illustrated). In some implementations, each virtual experience 105 may have a different ratio between the virtual experience engine functions that are performed on the online virtual experience server 102 and the virtual experience engine functions that are performed on the client device 110.

In some implementations, virtual experience instructions may refer to instructions that allow a client device 110 to render gameplay, graphics, and other features of a virtual experience. The instructions may include one or more of user input (e.g., physical object positioning), character position and velocity information, or commands (e.g., physics commands, rendering commands, collision commands, etc.).

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration, rather than limitation. In some implementations, any number of client devices 110 may be used.

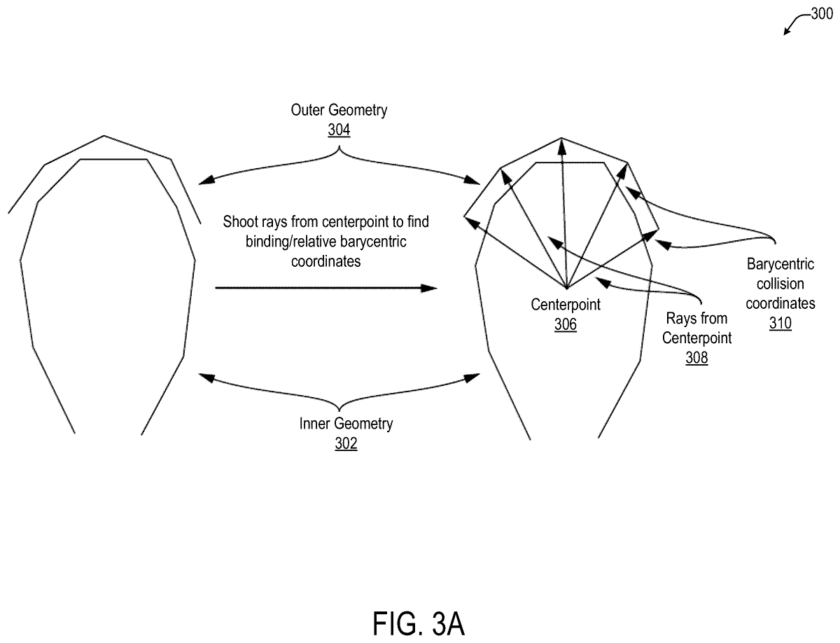

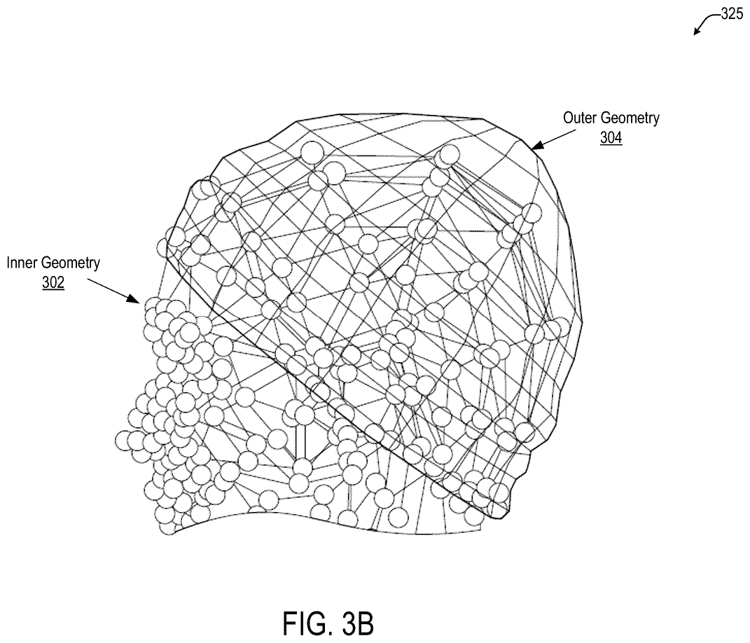

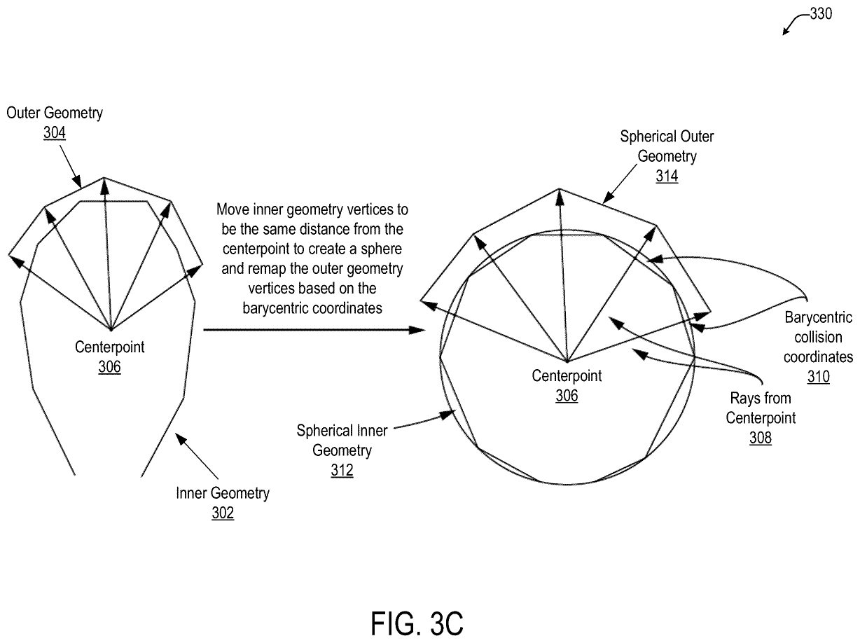

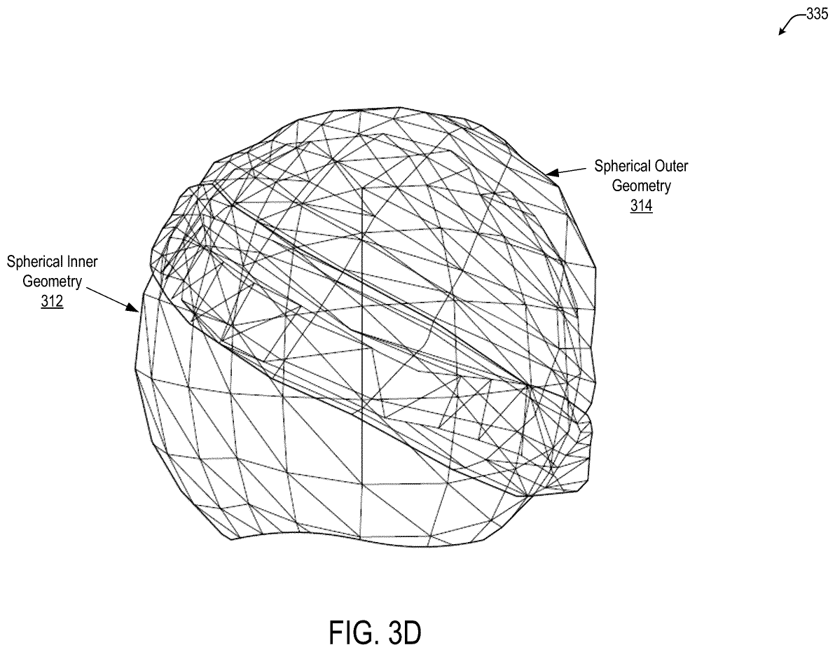

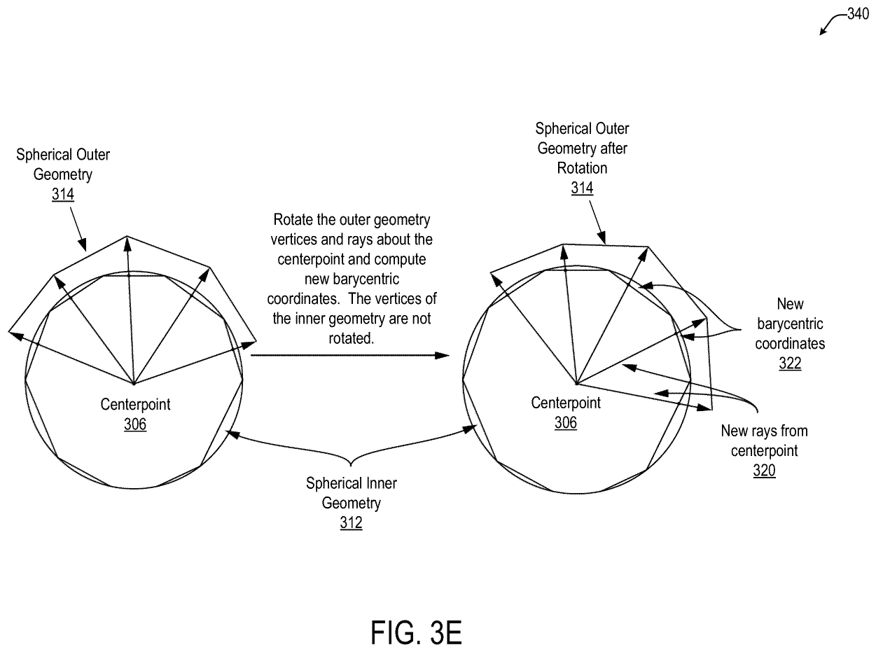

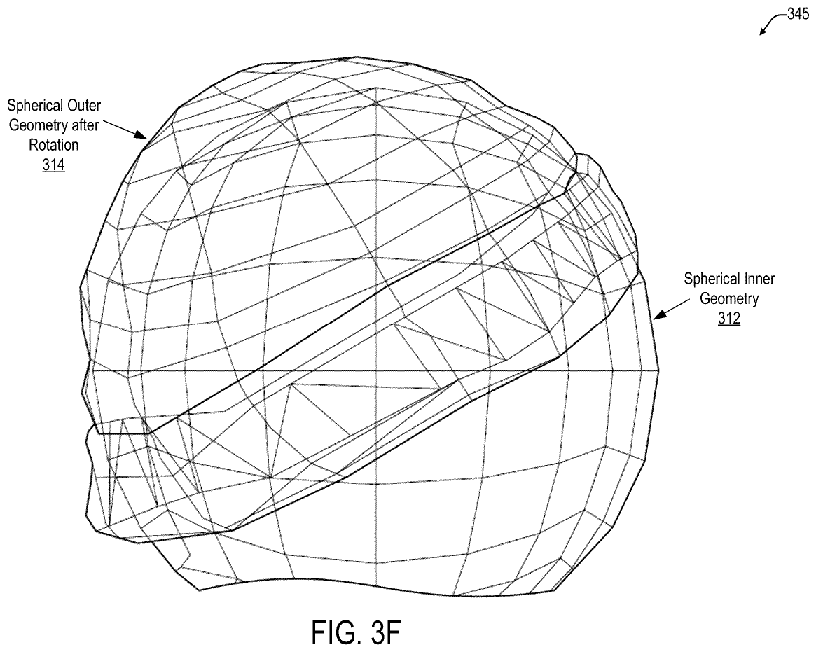

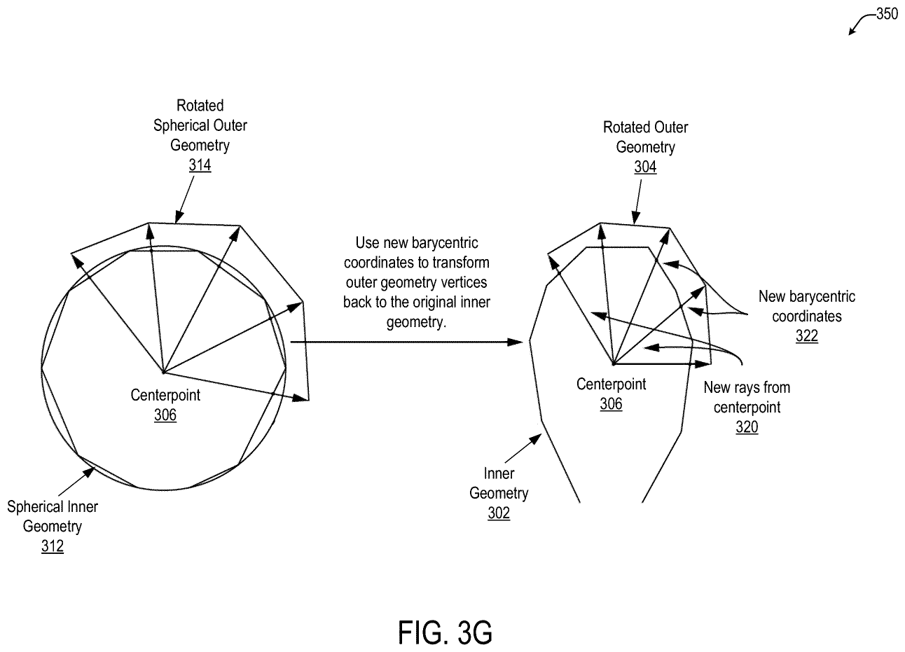

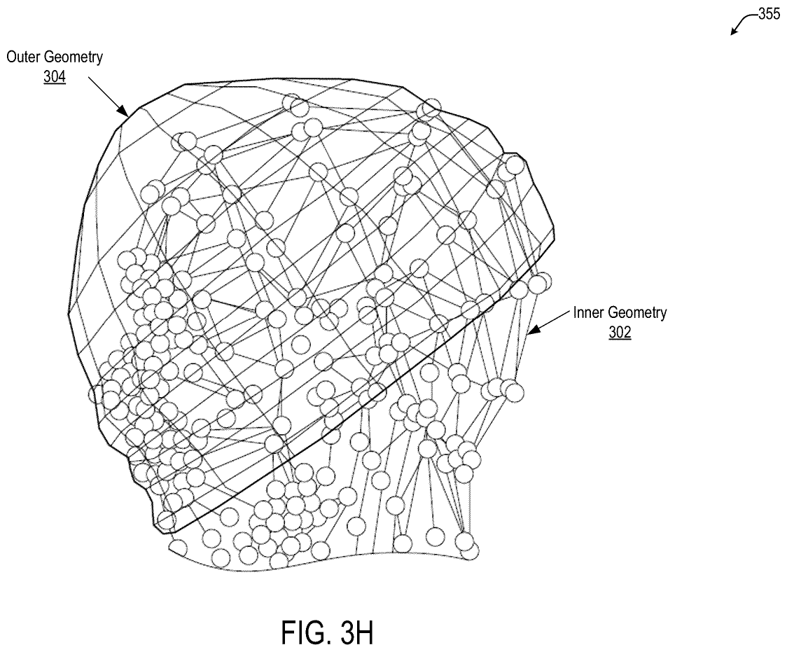

In some implementations, each client device 110 may include an instance of the virtual experience application 112. The virtual experience application 112 may be rendered for interaction at the client device 110. During user interaction within a virtual experience or another GUI of the network environment 100, a user may rotate an accessory positioned on an avatar's head. The accessory-rotation component 130 may take as input information related to the amount (e.g., degree) the accessory is rotated. Based on the degree of rotation, the accessory-rotation component 130 may compute the accessory in the rotated position on the avatar head, e.g., based on the operations described below with reference to FIGS. 3A-3H.

### Accessory in Neutral Position

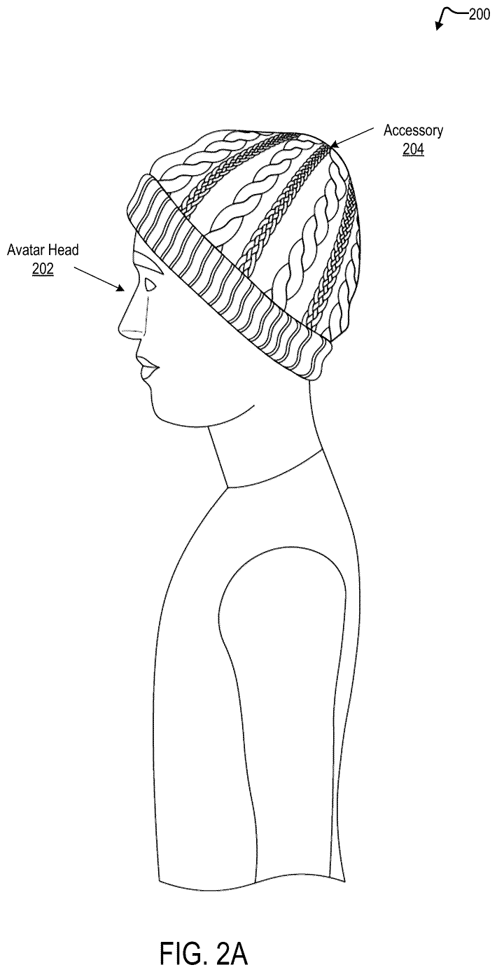

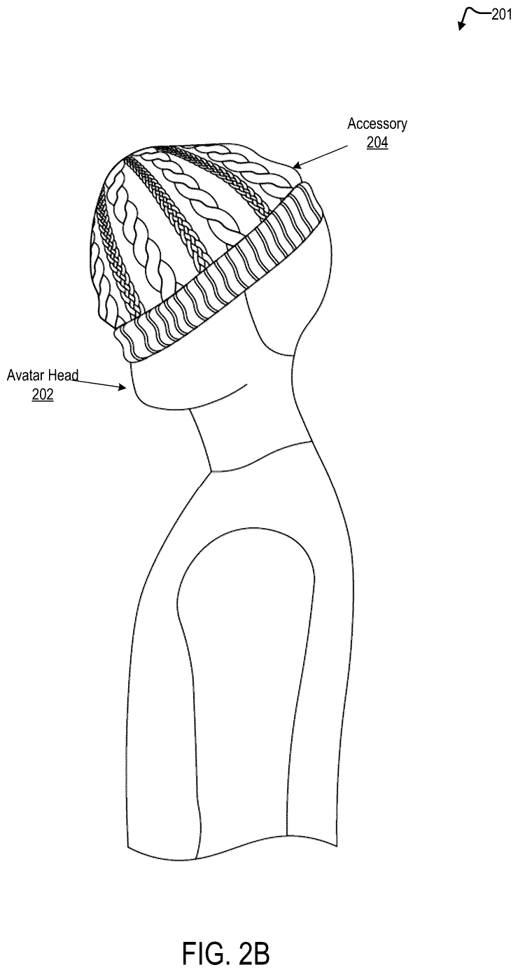

FIG. 2A is a diagram 200 of an accessory 204 in a neutral position on an avatar head 202, in accordance with some implementations. The accessory 204 in the neutral position may be bound to the avatar head 202, as described with reference to FIGS. 3A and 3B.

### Accessory in Rotated Position

FIG. 2B is a diagram 201 of an accessory 204 in a rotated position on an avatar head 202, in accordance with some implementations.

To rotate the accessory 204 on the avatar head 202, an inner geometry of the avatar head 202 is transformed to a spherical space, and the outer geometry of the accessory 204 is mapped to the spherical space, as described below with reference to FIGS. 3C and 3D. The outer geometry of the accessory 204 may then be rotated in the spherical space, as described below with reference to FIGS. 3E and 3F. Finally, the outer geometry of the accessory 204 is remapped back to the inner geometry of the avatar head 202, as described below in connection with FIGS. 3G and 3H.

### Binding an Outer Geometry of an Accessory to an Inner Geometry of an Avatar Head

FIG. 3A is a diagram illustrating a first set of operations 300 for rotating an accessory on an avatar head, in accordance with some implementations. For simplicity, the first set of operations 300 are shown in two-dimensional (2D) space but the same or similar operations may be performed in three-dimensional (3D) space.

Referring to FIG. 3A, the first set of operations 300 may be performed to bind an accessory to an avatar head. For instance, the center point 306 of the inner geometry 302 (e.g., avatar head cage) may be computed. Then, rays 308 may be extended from the center point 306 to each vertex of the outer geometry 304 of the accessory. The intersection points where the rays 308 collide with triangles (or other polygon shapes) on the outer surface of the inner geometry 302 are calculated. These intersections points form a first set of barycentric coordinates 310, which are stored for use in a second set of operations 330, as described below with reference to FIG. 3C.

### 3D Representation of Outer Geometry of Accessory Bound to Inner Geometry of Avatar Head

FIG. 3B illustrates a 3D representation 325 of the outer geometry 304 of an accessory in a neutral position bound to the inner geometry 302 of an avatar head, in accordance with some implementations. Referring to FIG. 3B, the outer geometry 304 may be bound to the inner geometry 302 based on the first set of operations 330 described above with reference to FIG. 3A.

In the non-limiting example of FIG. 3B, the inner geometry 302 is made up of a plurality of triangles, and the outer geometry 304 is made up of a plurality of quadrilaterals. However, the inner geometry 302 and the outer geometry 304 may each be made up of polygons of any type without departing from the scope of the present disclosure.

### Transforming Inner Geometry and Outer Geometry to Spherical Space

FIG. 3C is a diagram illustrating a second set of operations 330 for rotating an accessory, in accordance with some implementations. For simplicity, the second set of operations 330 are shown in 2D space but the same or similar operations may be performed in 3D space.

Referring to FIG. 3C, the second set of operations 330 may be performed to transform the inner geometry 302 of the avatar head to a spherical inner geometry 312, and to map the outer geometry 304 of the accessory to the spherical inner geometry 312. For instance, the position of each vertex in the inner geometry 302 may be adjusted to be the same distance from the center point 306, which transforms the inner geometry 302 to a spherical inner geometry 312.

Still referring to FIG. 3C, a delta may be calculated for each vertex in the inner geometry. The delta may be the difference in the original position of the vertex in the inner geometry 302 and the new position of the vertex in the spherical inner geometry 312. The deltas may be used to transform the vertices of the outer geometry 304 into a spherical outer geometry 314 by adjusting corresponding vertices in the outer geometry 304 based on the deltas. Then, the vertices of the spherical outer geometry 314 may be mapped to the vertices of the spherical inner geometry 312 based on the first set of barycentric coordinates 310. In some implementations, the outer geometry 304 may be mapped to the spherical inner geometry 312 by a linear deformer.

### 3D Representation of Spherical Outer Geometry and Spherical Inner Geometry

FIG. 3D illustrates a 3D representation 335 of the spherical outer geometry 314 of an accessory in a neutral position and the spherical inner geometry 312 of an avatar head, in accordance with some implementations. Referring to FIG. 3D, the spherical outer geometry 314 and the spherical inner geometry 312 may be calculated based on the second set of operations 330 described above with reference to FIG. 3C.

In the non-limiting example of FIG. 3D, the spherical inner geometry 312 is made up of a plurality of triangles, and the spherical outer geometry 314 is made up of a plurality of quadrilaterals. However, the spherical inner geometry 312 and the spherical outer geometry may each be made up of polygons of any type without departing from the scope of the present disclosure.

### Rotate Spherical Outer Geometry With Respect to Spherical Inner Geometry

FIG. 3E is a diagram illustrating a third set of operations 340 for rotating an accessory, in accordance with some implementations. For simplicity, the third set of operations 340 are shown in 2D space but the same or similar operations may be performed in 3D space.

Referring to FIG. 3E, the third set of operations 340 may be performed to rotate the spherical outer geometry 314 of the accessory with respect to the spherical inner geometry 312 of the avatar head. For instance, the spherical outer geometry 314 and the rays 320 that extend from the center point 306 of the spherical inner geometry 312 to the vertices of the spherical outer geometry 314 may be rotated.

The intersection points where the rays 320 collide with triangles (or other polygon shapes) on the outer surface of the spherical inner geometry 312 are calculated. These intersections points form a second set of barycentric coordinates 322, which are stored for use in a fourth set of operations 350, as described below with reference to FIG. 3G.

### 3D Representation of Spherical Outer Geometry in a Rotated Position on the Spherical Inner Geometry

FIG. 3F illustrates a 3D representation 345 of the spherical outer geometry 314 of an accessory in a rotated position on the spherical inner geometry 312 of an avatar head, in accordance with some implementations. Referring to FIG. 3F, the spherical outer geometry 314 may be rotated in relation to the spherical inner geometry 312 based on the third set of operations 340 described above with reference to FIG. 3E.

In the non-limiting example of FIG. 3F, the spherical inner geometry 312 is made up of a plurality of triangles, and the spherical outer geometry 314 is made up of a plurality of quadrilaterals. However, the spherical inner geometry 312 and the spherical outer geometry may each be made up of polygons of any type without departing from the scope of the present disclosure.

### Remap the Outer Geometry of the Accessory to the Inner Geometry of the Avatar Head

FIG. 3G is a diagram illustrating a fourth set of operations 350 for rotating an accessory, in accordance with some implementations. For simplicity, the fourth set of operations 350 are shown in 2D space but the same or similar operations may be performed in 3D space.

Referring to FIG. 3G, the fourth set of operations 350 may be performed to remap the outer geometry 304 of the accessory in the rotated position to the inner geometry 302 of the avatar head. For instance, the vertices of the spherical outer geometry 314 may be mapped to the vertices of the spherical inner geometry 312 based on the second set of barycentric coordinates 322. In some implementations, after rotating, the spherical outer geometry 314 may be mapped to the spherical inner geometry by an inverse-linear deformer. The spherical outer geometry 314 may be transformed back to the outer geometry 304 based on the second set of barycentric coordinates 322.

### 3D Representation of Outer Geometry in a Rotated Position on the Inner Geometry

FIG. 3H illustrates a 3D representation 355 of the outer geometry 304 of an accessory in a rotated position on the inner geometry 302 of an avatar head, in accordance with some implementations. Referring to FIG. 3H, the outer geometry 304 in the rotated position may be remapped to the inner geometry 302 based on the fourth set of operations 350 described above with reference to FIG. 3G.

In the non-limiting example of FIG. 3H, the inner geometry 302 is made up of a plurality of triangles, and the outer geometry 304 is made up of a plurality of quadrilaterals. However, the inner geometry 302 and the outer geometry 304 may each be made up of polygons of any type without departing from the scope of the present disclosure.

### Rotating Accessory Placed on Avatar Head

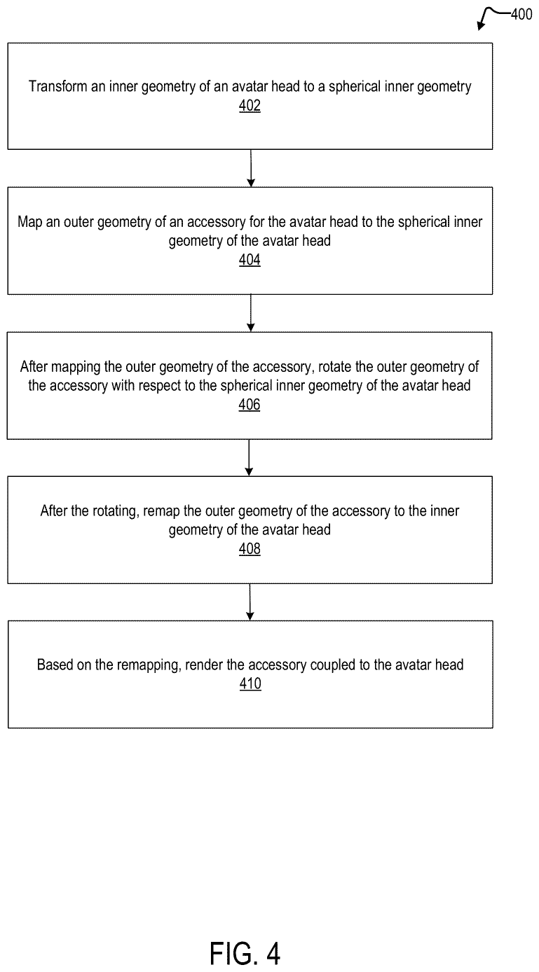

FIG. 4 is a flowchart illustrating an example method 400 to recommend content items, in accordance with some implementations. The method of FIG. 4 is implemented with specific user permission to access user data such as purchase history (e.g., of developer items such as avatar accessories, or other developer items), past play history (participation in one or more virtual experiences), context features such as the user-device type (e.g., desktop/laptop, smartphone, tablet, game console, or other computing device), user location (e.g., country), user language, or other features. In some implementations, the method of FIG. 4 may be implemented by accessory-rotation component 130. In different implementations, method 400 may be implemented as part of a virtual-experience application 112/120 and/or part of virtual experience engine 104.

Method 400 may begin at block 402. At block 402, an inner geometry of an avatar head may be transformed to a spherical inner geometry. Example operations are described above in connection with FIG. 3C.

In some implementations, transforming the inner geometry of the avatar head to the spherical inner geometry includes calculating a center point of the inner geometry of the avatar head. In some implementations, transforming the inner geometry of the avatar head to the spherical inner geometry includes adjusting vertices of the inner geometry to be a same distance from the center point to transform the inner geometry to the spherical inner geometry.

Block 404 may follow block 402. At block 404, an outer geometry of an accessory for the avatar head may be mapped to the spherical inner geometry of the avatar head. Example operations are described above in connection with FIG. 3C.

In some implementations, mapping the outer geometry of an accessory for the avatar head to the spherical inner geometry of the avatar head includes calculating a first set of barycentric coordinates that correspond to intersection points on an outer surface of the inner geometry for rays that extend from the center point of the inner geometry to the vertices of the outer geometry. In some implementations, mapping the outer geometry of an accessory for the avatar head to the spherical inner geometry of the avatar head includes calculating a delta for each vertex in the spherical inner geometry. In some implementations, the delta is a difference in an original position of the vertex in the inner geometry and a new position of the vertex in the spherical inner geometry. In some implementations, mapping the outer geometry of an accessory for the avatar head to the spherical inner geometry of the avatar head includes transforming the outer geometry of the accessory to a spherical outer geometry. In some implementations, mapping the outer geometry of an accessory for the avatar head to the spherical inner geometry of the avatar head includes mapping vertices of the spherical outer geometry of the accessory to vertices of the spherical inner geometry of the avatar head based on the first set of barycentric coordinates.

In some implementations, the mapping the outer geometry of the accessory for the avatar head to the spherical inner geometry of the avatar head is performed using a linear deformer.

Block 406 may follow block 404. At block 406, after mapping the outer geometry of the accessory, the outer geometry of the accessory may be rotated with respect to the spherical inner geometry of the avatar head. Example operations are described above with reference to FIG. 3E.

In some implementations, rotating the outer geometry of the accessory with respect to the spherical inner geometry of the avatar includes rotating the spherical outer geometry of the accessory and the rays that extend from the center point of the spherical inner geometry of the avatar head to the vertices of the spherical outer geometry.

Block 408 may follow block 406. At block 408, after the rotating, the outer geometry of the accessory may be remapped to the inner geometry of the avatar head. Example operations are described above with reference to FIG. 3G.

In some implementations, remapping the outer geometry of the accessory to the inner geometry of the avatar head includes calculating a second set of barycentric coordinates that correspond to new intersection points on an outer surface of the spherical inner geometry for the rays that extend from a center point of the spherical inner geometry to the vertices of the spherical outer geometry. In some implementations, remapping the outer geometry of the accessory to the inner geometry of the avatar head includes mapping the vertices of the spherical outer geometry to the vertices of the spherical inner geometry based on the second set of barycentric coordinates. In some implementations, remapping the outer geometry of the accessory to the inner geometry of the avatar head includes transforming the spherical outer geometry back to the outer geometry based on the second set of barycentric coordinates.

In some implementations, the remapping the outer geometry of the accessory to the inner geometry of the avatar head is performed using an inverse-linear deformer.

Block 410 may follow block 408. At block 410, based on the remapping, the accessory coupled to the avatar head may be rendered. An example of the accessory in the rotated position coupled to the avatar head is shown in FIG. 2B.

In some implementations, rendering the accessory in a rotated position resting on the avatar head includes rendering the accessory coupled to the avatar head after the spherical outer geometry is transformed back to the outer geometry.

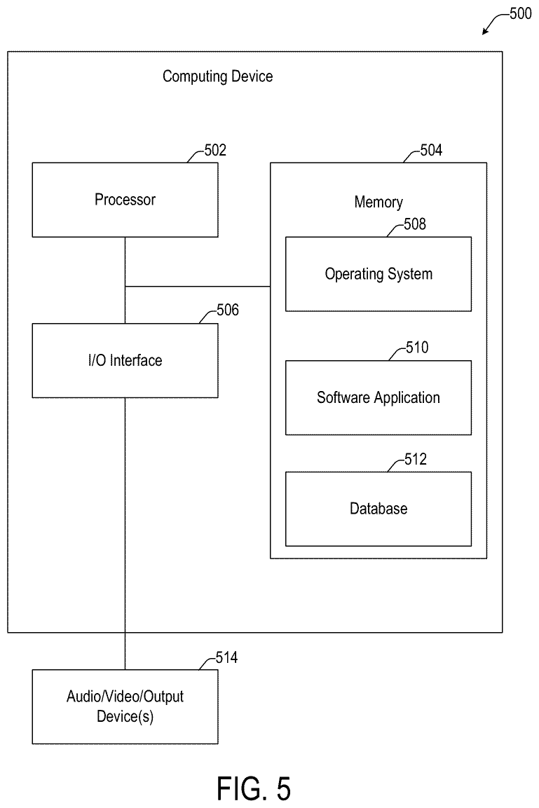

### FIG. 5: Computing Devices

Hereinafter, a more detailed description of various computing devices that may be used to implement different devices and/or components illustrated in FIG. 1 is provided with reference to FIG. 5.

FIG. 5 is a block diagram of an example computing device 500 which may be used to implement one or more features described herein, in accordance with some implementations. In one example, the computing device 500 may be used to implement a computer device, (e.g., 102, 110 of FIG. 1), and perform appropriate operations as described herein. Computing device 500 can be any suitable computer system, server, or other electronic or hardware device. For example, the computing device 500 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, the computing device 500 includes a processor 502, a memory 504, input/output (I/O) interface 506, and audio/video input/output devices 514 (e.g., display screen, touchscreen, display goggles or glasses, audio speakers, headphones, microphone, etc.).

Processor 502 can be one or more processors and/or processing circuits to execute program code and control basic operations of the computing device 500. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 504 is typically provided in the computing device 500 for access by the processor 502, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 502 and/or integrated therewith. Memory 504 can store software operating on the computing device 500 by the processor 502, including an operating system 508, software application 510, and associated database 512. In some implementations, the software application 510 can include instructions that enable processor 502 to perform the functions described herein. Software application 510 may include some or all of the functionality used to calculate an accessory in a rotated position coupled to an avatar head. In some implementations, one or more portions of software application 510 may be implemented in dedicated hardware such as an application-specific integrated circuit (ASIC), a programmable logic device (PLD), a field-programmable gate array (FPGA), a machine learning processor, etc. In some implementations, one or more portions of software application 510 may be implemented in general purpose processors, such as a central processing unit (CPU) or a graphics processing unit (GPU). In various implementations, suitable combinations of dedicated and/or general-purpose processing hardware may be used to implement software application 510.

For example, software application 510 stored in memory 504 can include instructions for calculating an accessory in a rotated position coupled to an avatar head, and/or other functionality or software such as the accessory-rotation component 130, virtual experience engine 104, and/or virtual experience application 112. Any of software in memory 504 can alternatively be stored on any other suitable storage location or computer-readable medium. In addition, memory 504 (and/or other connected storage device(s)) can store instructions and data used in the features described herein. Memory 504 and any other type of storage (magnetic disk, optical disk, magnetic tape, or other tangible media) can be considered “storage” or “storage devices.”

I/O interface 506 can provide functions to enable interfacing the computing device 500 with other systems and devices. For example, network communication devices, storage devices (e.g., memory and/or data store 106), and input/output devices can communicate via I/O interface 506. In some implementations, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 5 shows one block for each of processor 502, memory 504, I/O interface 506, operating system 508, software application 510, and database 512. These blocks may represent one or more processors or processing circuitries, operating systems, memories, I/O interfaces, applications, and/or software modules. In other implementations, the computing device 500 may not have all of the components shown and/or may have other elements including other types of elements instead of, or in addition to, those shown herein. While the online virtual experience server 102 are described as performing operations as described in some implementations herein, any suitable component or combination of components of online virtual experience server 102, or similar system, or any suitable processor or processors associated with such a system, may perform the operations described.

A user device can also implement and/or be used with features described herein. Example user devices can be computer devices including some similar components as the computing device 500, e.g., processor(s) 502, memory 504, and I/O interface 506. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 514, for example, can be connected to (or included in) the computing device 500 to display images pre-and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more methods described herein (e.g., method 400) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the live feedback data for output (e.g., for display). In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method, comprising:
transforming, by a processor, an inner geometry of an avatar head to a spherical inner geometry;
mapping, by the processor, an outer geometry of an accessory for the avatar head to the spherical inner geometry of the avatar head;
after mapping the outer geometry of the accessory, rotating, by the processor, the outer geometry of the accessory with respect to the spherical inner geometry of the avatar head;
after the rotating, remapping, by the processor, the outer geometry of the accessory to the inner geometry of the avatar head; and
based on the remapping, rendering, by the processor, the accessory coupled to the avatar head.

2. The computer-implemented method of claim 1, wherein transforming the inner geometry of the avatar head to the spherical inner geometry comprises:
calculating a center point of the inner geometry of the avatar head; and
adjusting vertices of the inner geometry to be a same distance from the center point to transform the inner geometry to the spherical inner geometry.

3. The computer-implemented method of claim 2, wherein mapping the outer geometry of an accessory for the avatar head to the spherical inner geometry of the avatar head comprises:
calculating a first set of barycentric coordinates that correspond to intersection points on an outer surface of the inner geometry for rays that extend from the center point of the inner geometry to the vertices of the outer geometry;
calculating a delta for each vertex in the spherical inner geometry, the delta being a difference in an original position of the vertex in the inner geometry and a new position of the vertex in the spherical inner geometry;
transforming the outer geometry of the accessory to a spherical outer geometry; and
mapping vertices of the spherical outer geometry of the accessory to vertices of the spherical inner geometry of the avatar head based on the first set of barycentric coordinates.

4. The computer-implemented method of claim 3, wherein rotating the outer geometry of the accessory with respect to the spherical inner geometry of the avatar head comprises:
rotating the vertices of the spherical outer geometry of the accessory and the rays that extend from the center point of the spherical inner geometry of the avatar head to the vertices of the spherical outer geometry.

5. The computer-implemented method of claim 4, wherein remapping the outer geometry of the accessory to the inner geometry of the avatar head comprises:
calculating a second set of barycentric coordinates that correspond to new intersection points on an outer surface of the spherical inner geometry for the rays that extend from a center point of the spherical inner geometry to the vertices of the spherical outer geometry;
mapping the vertices of the spherical outer geometry to the vertices of the spherical inner geometry based on the second set of barycentric coordinates; and
transforming the spherical outer geometry back to the outer geometry based on the second set of barycentric coordinates.

6. The computer-implemented method of claim 5, wherein rendering the accessory in a rotated position resting on the avatar head comprising:
rendering the accessory coupled to the avatar head after the spherical outer geometry is transformed back to the outer geometry.

7. The computer-implemented method of claim 1, wherein:
the mapping the outer geometry of the accessory for the avatar head to the spherical inner geometry of the avatar head is performed using a linear deformer, and
the remapping the outer geometry of the accessory to the inner geometry of the avatar head is performed using an inverse-linear deformer.

8. A non-transitory computer-readable medium with instructions stored thereon that, when executed by one or more hardware processors, cause the one or more hardware processors to perform operations comprising:
transforming an inner geometry of an avatar head to a spherical inner geometry;
mapping an outer geometry of an accessory for the avatar head to the spherical inner geometry of the avatar head;
after mapping the outer geometry of the accessory, rotating the outer geometry of the accessory with respect to the spherical inner geometry of the avatar head;
after the rotating, remapping the outer geometry of the accessory to the inner geometry of the avatar head; and
based on the remapping, rendering the accessory coupled to the avatar head.

9. The non-transitory computer-readable medium of claim 8, wherein transforming the inner geometry of the avatar head to the spherical inner geometry comprises:
calculating a center point of the inner geometry of the avatar head; and
adjusting vertices of the inner geometry to be a same distance from the center point to transform the inner geometry to the spherical inner geometry.

10. The non-transitory computer-readable medium of claim 9, wherein mapping the outer geometry of an accessory for the avatar head to the spherical inner geometry of the avatar head comprises:
calculating a first set of barycentric coordinates that correspond to intersection points on an outer surface of the inner geometry for rays that extend from the center point of the inner geometry to the vertices of the outer geometry;
calculating a delta for each vertex in the spherical inner geometry, the delta being a difference in an original position of the vertex in the inner geometry and a new position of the vertex in the spherical inner geometry;
transforming the outer geometry of the accessory to a spherical outer geometry; and
mapping vertices of the spherical outer geometry of the accessory to vertices of the spherical inner geometry of the avatar head based on the first set of barycentric coordinates.

11. The non-transitory computer-readable medium of claim 10, wherein rotating the outer geometry of the accessory with respect to the spherical inner geometry of the avatar head comprises:
rotating the vertices of the spherical outer geometry of the accessory and the rays that extend from the center point of the spherical inner geometry of the avatar head to the vertices of the spherical outer geometry.

12. The non-transitory computer-readable medium of claim 11, wherein remapping the outer geometry of the accessory to the inner geometry of the avatar head comprises:
calculating a second set of barycentric coordinates that correspond to new intersection points on an outer surface of the spherical inner geometry for the rays that extend from a center point of the spherical inner geometry to the vertices of the spherical outer geometry;
mapping the vertices of the spherical outer geometry to the vertices of the spherical inner geometry based on the second set of barycentric coordinates; and
transforming the spherical outer geometry back to the outer geometry based on the second set of barycentric coordinates.

13. The non-transitory computer-readable medium of claim 12, wherein rendering the accessory in a rotated position resting on the avatar head comprising:
rendering the accessory coupled to the avatar head after the spherical outer geometry is transformed back to the outer geometry.

14. The non-transitory computer-readable medium of claim 8, wherein:
the mapping the outer geometry of the accessory for the avatar head to the spherical inner geometry of the avatar head is performed using a linear deformer, and
the remapping the outer geometry of the accessory to the inner geometry of the avatar head is performed using an inverse-linear deformer.

15. A computing device, comprising:
one or more hardware processors; and
a non-transitory computer readable medium coupled to the one or more hardware processors, with instructions stored thereon, that when executed by the one or more hardware processors to perform operations comprising:
transforming an inner geometry of an avatar head to a spherical inner geometry;
mapping an outer geometry of an accessory for the avatar head to the spherical inner geometry of the avatar head;
after mapping the outer geometry of the accessory, rotating the outer geometry of the accessory with respect to the spherical inner geometry of the avatar head;
after the rotating, remapping the outer geometry of the accessory to the inner geometry of the avatar head; and
based on the remapping, rendering the accessory coupled to the avatar head.

16. The computing device of claim 15, wherein transforming the inner geometry of the avatar head to the spherical inner geometry comprises:
calculating a center point of the inner geometry of the avatar head; and
adjusting vertices of the inner geometry to be a same distance from the center point to transform the inner geometry to the spherical inner geometry.

17. The computing device of claim 16, wherein mapping the outer geometry of an accessory for the avatar head to the spherical inner geometry of the avatar head comprises:
calculating a first set of barycentric coordinates that correspond to intersection points on an outer surface of the inner geometry for rays that extend from the center point of the inner geometry to the vertices of the outer geometry;
calculating a delta for each vertex in the spherical inner geometry, the delta being a difference in an original position of the vertex in the inner geometry and a new position of the vertex in the spherical inner geometry;
transforming the outer geometry of the accessory to a spherical outer geometry; and
mapping vertices of the spherical outer geometry of the accessory to vertices of the spherical inner geometry of the avatar head based on the first set of barycentric coordinates.

18. The computing device of claim 17, wherein rotating the outer geometry of the accessory with respect to the spherical inner geometry of the avatar head comprises:
rotating the vertices of the spherical outer geometry of the accessory and the rays that extend from the center point of the spherical inner geometry of the avatar head to the vertices of the spherical outer geometry.

19. The computing device of claim 18, wherein remapping the outer geometry of the accessory to the inner geometry of the avatar head comprises:
calculating a second set of barycentric coordinates that correspond to new intersection points on an outer surface of the spherical inner geometry for the rays that extend from a center point of the spherical inner geometry to the vertices of the spherical outer geometry;
mapping the vertices of the spherical outer geometry to the vertices of the spherical inner geometry based on the second set of barycentric coordinates; and
transforming the spherical outer geometry back to the outer geometry based on the second set of barycentric coordinates.

20. The computing device of claim 19, wherein rendering the accessory in a rotated position resting on the avatar head comprising:
rendering the accessory coupled to the avatar head after the spherical outer geometry is transformed back to the outer geometry.
